(19) United States
(12) Patent Application Publication
(10) Pub. No.: US 2022/0270004 A1
(43) Pub. Date: Aug. 25, 2022

(54) Micro-Level and Macro-Level Predictions in Sports

(71) Applicant: STATS LLC, Chicago, IL (US)

(72) Inventors: Hector Ruiz, Barcelona (ES); Nils Sebastiaan Mackaij, Amsterdam (NL); Christian Marko, Graz (AT); Patrick Joseph Lucey, Chicago, IL (US)

(73) Assignee: STATS LLC, Chicago, IL (US)

(21) Appl. No.: 17/651,960

(22) Filed: Feb. 22, 2022

Related U.S. Application Data
(60) Provisional application No. 63/152,106, filed on Feb. 22, 2021.

(51) Int. Cl. G06Q 10/04; G06N 7/00

(52) U.S. Cl. CPC G06Q 10/04; G06N 7/00

(57) ABSTRACT

A method is disclosed herein. A computing system receives a data feed for an event. The data feed includes real-time player and team information. The computing system generates a feature representation of the data feed. The computing system generates micro predictions for the event. The micro predictions for the event are associated with predictions at a match level. The computing system generates macro predictions for each team involved in the event. The macro predictions are associated with predictions across one or more seasons. The computing system generates an output. The output includes the micro predictions and the macro predictions.

### CROSS-REFERENCE TO RELATED APPLICATIONS

This application claims priority to U.S. Application Ser. No. 63/152,106, filed Feb. 22, 2021, which is hereby incorporated by reference in its entirety.

### FIELD OF THE DISCLOSURE

The present disclosure generally relates to a system and method for predicting micro and macro outcomes in sports using fast and deep data sources.

### BACKGROUND

Increasingly, sports fans and data analysts have become entrenched in sports analytics. Fans and analysts continually debate not only the outcome of a particular match, but also player performance within the match and team performance within the match. As sports data has become more advanced, fans and analysts have become more interested in player and team performance across a season or a plurality of seasons.

### SUMMARY

In some embodiments, a method is disclosed herein. A computing system receives a data feed for an event. The data feed includes real-time player and team information. The computing system generates model features for use with a micro prediction module and a macro prediction module based on the data feed and historical information associated with teams and/or players in the event. The computing system generates micro predictions for the event. The micro predictions for the event are associated with player and team predictions at an event level. The computing system generates macro predictions for the players and the teams involved in the event based on the model features and the micro predictions generated by the micro prediction module. The computing system posts the micro predictions and the macro predictions to an event feed.

In some embodiments, a non-transitory computer readable medium is disclosed herein. The non-transitory computer readable medium includes one or more sequences of instructions, which, when executed by a processor, causes a computing system to perform operations. The operations include receiving, by the computing system, a data feed for an event. The data feed includes real-time player and team information. The operations further include generating, by the computing system, a model features for use with a micro prediction module and a macro prediction module based on the data feed and historical information associated with teams and/or players in the event. The operations further include generating, by the computing system, micro predictions for the event. The micro predictions for the event are associated with player and team predictions at an event level. The operations further include generating, by the computing system, macro predictions for the players and the teams involved in the event based on the model features and the micro predictions generated by the micro prediction module. The operations further include posting, by the computing system, the micro predictions and the macro predictions to an event feed.

In some embodiments, a system is disclosed herein. The system includes a processor and a memory. The memory includes programming instructions stored thereon, which, when executed by the processor, causes the system to perform operations. The operations include receiving a data feed for an event. The data feed includes real-time player and team information. The operations further include generating a model feature for use with a micro prediction module and a macro prediction module based on the data feed and historical information associated with teams and/or players in the event. The operations further include generating micro predictions for the event. The micro predictions for the event are associated with player and team predictions at an event level. The operations further include generating macro predictions for the players and the teams involved in the event based on the model features and the micro predictions generated by the micro prediction module. The operations further include posting the micro predictions and the macro predictions to an event feed.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a block diagram illustrating prediction engine in more detail, according to example embodiments.

FIG. 3 is a block diagram illustrating a micro prediction process, according to example embodiments.

FIG. 4 is a block diagram illustrating a macro prediction process, according to example embodiments.

FIG. 5 is a flow diagram illustrating a method of generating micro predictions and macro predictions in sport, according to example embodiments.

FIG. 6A is a block diagram illustrating a computing device, according to example embodiments.

FIG. 6B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

One or more techniques described herein generally relate to a system and method for predicting micro and macro outcomes in sports using both fast and deep data sources through a bottom-up representation. Using both fast and deep data sources may provide the present system with both ultrafast data, which may provide instantaneous information about a game or event, as well as deep data, which may provide specific event information, such as, but not limited to location and player identity. Utilizing both sets of data may allow the system to generate both micro predictions and macro predictions. A micro prediction may refer to a prediction within a single game or event. Example micro predictions may include, but are not limited to, a final outcome probability, final statistics of each team, final statistics of each player, and the like. A macro prediction may refer to a prediction across a season. Example macro predictions may include, but are not limited to, a final league standings (and probabilities of each), final team statistics, final player statistics, and the like.

To generate such predictions, one or more techniques described herein may utilize a “bottom-up” representation. The bottom-up representation may include the system utilizing data of each individual player and team into a single group representation, which may enable all predictions to come from the same data source, thus ensuring self-consistency as well as enabling interactive questions.

The present approach provides an improvement over conventional systems. For example, conventional approaches typically have been performed in the sportsbook area. Sportsbook techniques typically leverage data-driven approaches, as well as predictive markets, with human interactions. The present system improves upon such techniques through the use of the unified bottom-up approach, which utilizes the micro predictions and feeds those micro predictions into the system to generate macro predictions. Further, through the present approach, there is no need to rely on market information and instead may rely solely on data-driven techniques. Such shift in reliance from a market information-driven system to the present data-driven techniques may allow for predictions to be generated anytime (e.g., in real-time, near real-time, etc.) based on any scenario.

Although the present application focuses on the sport of soccer as the use-case, those skilled in the art understand that the present techniques can be applied to sports beyond soccer, such as, but not limited to, basketball, football, hockey, rugby, and the like.

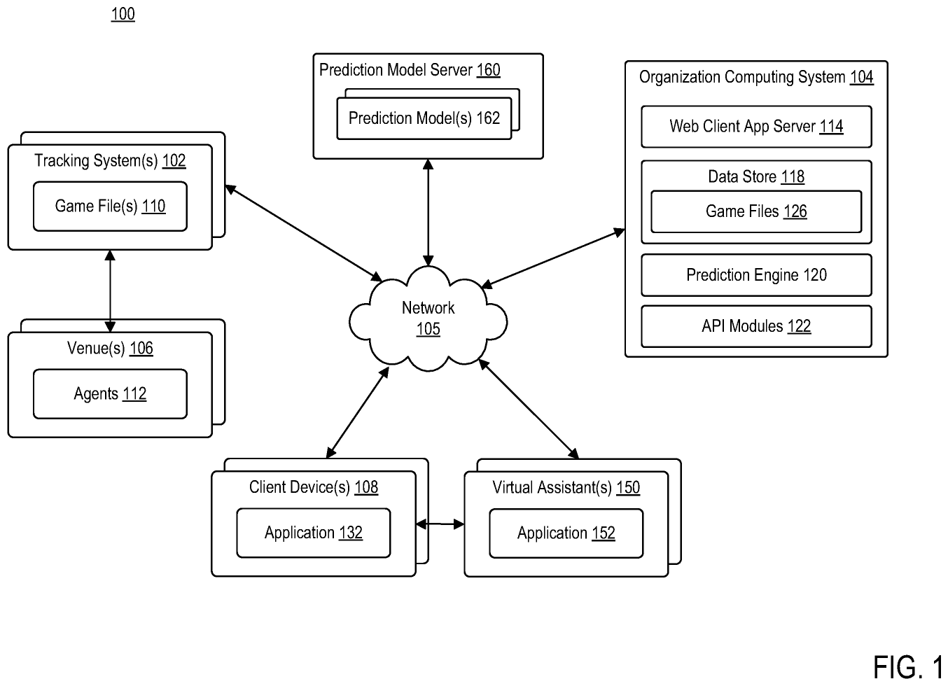

FIG. 1 is a block diagram illustrating a computing environment 100, according to example embodiments. Computing environment 100 may include tracking system 102, organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™ ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106. For example, venue 106 may be configured to host a sporting event that includes one or more agents 112. Tracking system 102 may be configured to record the motions of all agents (i.e., players) on the playing surface, as well as one or more other objects of relevance (e.g., ball, referees, etc.). In some embodiments, tracking system 102 may be an optically-based system using, for example, a plurality of fixed cameras. For example, a system of six stationary, calibrated cameras, which project the three-dimensional locations of players and the ball onto a two-dimensional overhead view of the court may be used. In some embodiments, tracking system 102 may be a radio-based system using, for example, radio frequency identification (RFID) tags worn by players or embedded in objects to be tracked. Generally, tracking system 102 may be configured to sample and record, at a high frame rate. Tracking system 102 may be configured to store at least player identity and positional information (e.g., (x, y) position) for all agents and objects (e.g., ball, puck, etc.) on the playing surface for each frame in a game file 110.

Tracking system 102 may be configured to communicate with organization computing system 104 via network 105. Organization computing system 104 may be configured to manage and analyze the data captured by tracking system 102. Organization computing system 104 may include at least a web client application server 114, a data store 118, a prediction engine 120, and application programming interface (API) modules 122. Each of prediction engine 120 and API modules 122 may be comprised of one or more software modules. The one or more software modules may be collections of code or instructions stored on a media (e.g., memory of organization computing system 104) that represent a series of machine instructions (e.g., program code) that implement one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Data store 118 may be configured to store one or more game files 126. Each game file 126 may be captured and generated by a tracking system 102. In some embodiments, each of the one or more game files 126 may include all the raw data captured from a particular game or event. For example, the raw data captured from a particular game or event may include x-,y-coordinates of the game. In some embodiments, each game file 126 may further include Opta event-level data. For example, in some embodiments, tracking system 102 may be representative of an Opta data feed.

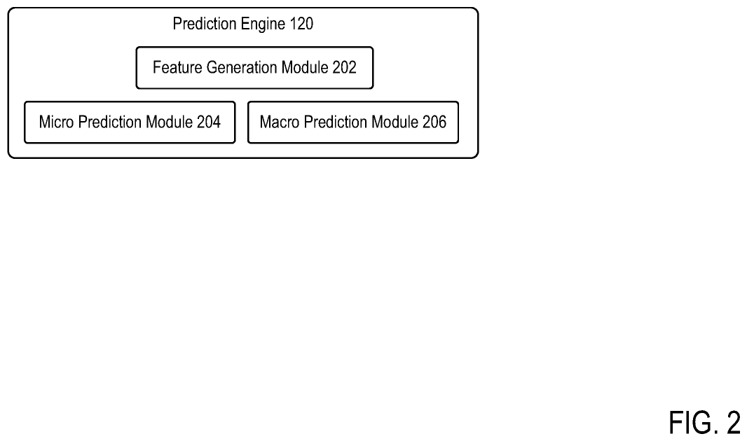

Prediction engine 120 may be configured to generate one or more micro-level predictions and one or more macro-level predictions based on received data. For example, as discussed in further detail below in conjunction with FIG. 2, prediction engine 120 may be configured to initiate generation of micro predictions and macro predictions based on the detection of one or more trigger events. In some embodiments, the one or more trigger events may be determined based on the incoming data feed (e.g., Opta data feed). In some embodiments, the one or more trigger events may be time-based, as set by a user or administrator.

API modules 122 may allow one or more external devices (e.g., client devices 108 and/or virtual assistants 150) to access functionality of prediction engine 120.

Prediction model server 160 may be configured to host one or more prediction models 162 accessed by prediction engine 120. Exemplary prediction models 162 may include, for example, a prediction model trained to predict the probability of each possible final score (or remaining score), the probability of the final result (win/loss/tie), a prediction model trained to predict the individual statistic of each player or team (e.g., number of shots, passes in soccer/basketball), a prediction model trained to predict which team will win the championship/league at the end of the season (or their probability of each place on the ladder), and/or a prediction model trained to predict each player/team final season statistics.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 132. Application 132 may be representative of a web browser that allows access to a website or a stand-alone application. Client device 108 may use access application 132 to access one or more functionalities of organization computing system 104. Client device 108 may communicate over network 105 to request a webpage, for example, from web client application server 114 of organization computing system 104. For example, client device 108 may be configured to execute application 132 to access content managed by web client application server 114. The content that is displayed to client device 108 may be transmitted from web client application server 114 to client device 108, and subsequently processed by application 132 for display through a graphical user interface (GUI) of client device 108.

In some embodiments, application 132 may provide a user with access to functionality of prediction engine 120 using one or more API endpoints established by API modules 122. For example, application 132 may call prediction engine 120 using an API call to an API endpoint associated therewith.

In some embodiments, computing environment 100 may further include one or more virtual assistants 150. In some embodiments, one or more virtual assistants 150 may be representative of stand-alone devices configured to receive, process, and understand voice commands from an end user. In some embodiments, one or more virtual assistants 150 may be representative of virtual assistants integrated with a client device 108. In some embodiments, virtual assistant 150 may include application 152. Application 152 may allow virtual assistant 150 to one or more functionalities of organization computing system 104. Virtual assistant 150 may communicate over network 105 a request to organization computing system 104 for a micro prediction and/or a macro prediction.

In operation, virtual assistant 150 may receive a voice command from a user. Virtual assistant 150 may use one or more natural language understanding technologies to process and understand the voice command from the user. In some embodiments, virtual assistant 150 may translate the voice command to a format compatible with prediction engine 120. Virtual assistant 150 may provide the query to organization computing system 104 via one or more API endpoints established by one or more API modules 122. Once prediction engine 120 generates a response to the user's question, organization computing system 104 may provide virtual assistant 150 with a response for responding to the user. Virtual assistant 150 may generate an audible response to the end user.

Exemplary questions may include, but are not limited to: “How many shots is Team A going to get this game?”, “How many passes or shots is Player X going to get for the rest of this game?”, “What is the probability that Team B will get 3 goals, or 20 shots this game/half”, “If we brought on Player Y now, how many shots is Team C going to get, and how many shots is Player Y going to get?”, “If the score remains the same, what is the probability Team D will get relegated/win the premier league?”, and the like.

FIG. 2 is a block diagram illustrating prediction engine 120 in more detail, according to example embodiments.

As shown, prediction engine 120 may include feature generation module 202, micro prediction module 204, and macro prediction module 206. Each of feature generation module 202, micro prediction module 204, and macro prediction module 206 may be comprised of one or more software modules. The one or more software modules may be collections of code or instructions stored on a media (e.g., memory of organization computing system 104) that represent a series of machine instructions (e.g., program code) that implement one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Feature generation module 202 may be configured to generate model features for use with micro prediction module 204 and/or macro prediction module 206. For example, feature generation module 202 may be configured to obtain data related to teams or players in a current game of interest, as well as historical games of interest related to the teams, players, and/or other teams and players. In some embodiments, feature generation module 202 may access historical information stored in game files 126 of data store 118. In some embodiments, feature generation module 202 may access real-time or near real-time data via one or more APIs associated with Opta Data Feeds. For example, feature generation module 202 may submit one or more GET requests to a soccer Opta SDAPI.

In some embodiments, the features generated by feature generation module 202 may be grouped into a plurality of sets based on the type of prediction for which the feature is used and the context to which the feature is related. In some embodiments, feature generation module 202 may generate the features for a specific game, and the downstream models may use the features to make predictions about the specific game. Exemplary feature groups may include: pre-game team features, in-game team features, player usage features, pre-game player features, and in-game player features.

Pre-game team features (e.g., team_pregame) may include features related to the home team and the away team for a specific game. Pre-game team features may capture information that is available before the game starts and that does not change after the game starts. Exemplary pre-game features may include, but are not limited to, team strength (e.g., pre-game odds), opposition strength, a home team flag (e.g., if home=0, if away=1), recent team play, recent opponent play, and relative team strength (which can be obtained using the pre-game market odds, ELO measures or the recent performances across the last 5 games which are captured by taking the recent key statistics (how many wins, goals, passes etc.))

In-game team features (e.g., team_ingame) may include features related to the home team and the away team for a specific game. In-game team features may describe the in-game context of the match at the team level. Such in-game team features may be dynamic in nature, changing constantly throughout the game. Exemplary in-game features may include, but are not limited to, players on the field, in game team stats, current time, current score, which team is in possession, whether a team has had a player sent-off, and current in-game statistics (number of shots, passes etc., or using more advanced statistics such as expected goals, assists, possession value, etc.).

Player usage features (player_usage) may include features related to the usage of the player in the games played by his teams recently. In some embodiments, player usage features may include features related to the usage of the player in the last three games his teams played. Exemplary player usage features may include, but are not limited to features which capture a player's specific role/position in a team (forward, defender), and the specific in-game statistic of that player (whether it is total counts or a percentage of the overall team statistics or goals, passes, shots etc.).

Player pre-game features (player_pregame) may include features about a player in the target game. Player pre-game features may capture information available before the game starts and that does not change after the start of the game. Exemplary player pre-game features may include, but are not limited to: starter flag (e.g., if starter=0, if reserve=1), role/position, recent player play. More generally, player pre-game features may be representative of player specific features of a player's historic (long-term) and short-term performances across key statistics such as goals, passes, shots, etc.

Player in-game features (player_ingame) may include features about a player in the target game. Player in-game features may describe the in-game context of the match at the team and player levels. In some embodiments, player in-game features may constantly change during a course of the game. Player in-game features me be representative of features which capture a player's specific role/position in a team (forward, defender), and the specific in-game statistic of that player (whether it is total counts or a percentage of the overall team statistics or goals, passes, shots etc.). Exemplary player in-game features may include, but are not limited to: if on the playing surface, in-game player statistics, and the like.

In some embodiments, feature generation module 202 may be triggered in various ways. Each trigger may affect how a calculation generated by feature generation module 202 is carried out. In some embodiments, feature generation module 202 may be manually triggered by an end user, administrator, or operator. In some embodiments, feature generation module 202 may be triggered automatically by, for example, writing a bit of code which instructs the processes to trigger without waiting for a specific trigger event to occur. In some embodiments, feature generation module 202 may be triggered by the detection of one or more trigger events present in the Opta data feed. Exemplary trigger events may include, but are not limited to, goals scored, shots, corner kicks, substitutions, red cards, yellow cards, and specific time intervals (e.g., minutes, seconds). Such trigger events may further cause feature generation module 202 to trigger or initialize micro prediction module 204 and/or macro prediction module 206.

Feature generation module 202 may save or store the generated features in data store 118. Such features may be accessible to various prediction models of organization computing system 104.

Micro prediction module 204 may be configured to generate one or more predictions on a micro-level. In some embodiments, a micro-level prediction may refer to a game or match level prediction as opposed to a season-level prediction. Micro prediction module 204 may be triggered by feature generation module 202. For example, responsive to identifying one of the defined trigger events referenced above, feature generation module 202 may cause micro prediction module 204 to activate.

Once activated, micro prediction module 204 may selectively retrieve features, generated by feature generation module 202, from data store 118. In some embodiments, all features generated by feature generation module 202 may be used. Prediction models may weight which features to use (ones which are not important will have a zero weighting). Using the retrieved features, micro prediction module 204 may make one or more hypertext transfer protocol (HTTP) requests to endpoints where the various prediction models are deployed to generate the micro predictions. Once the predictions are generated and received from the various prediction models, micro prediction module 204 may format and write the predictions to data store 118. In some embodiments, the predictions may be stored in a table separate from a table storing the generated features.

In some embodiments, micro prediction module 204 may further be configured to publish the received predictions to one or more data streams. For example, micro prediction module 204 may publish the received predictions to a Kinesis data stream. In some embodiments, micro prediction module 204 may publish the team-level predictions to a first data stream and the player-level predictions to a second data stream.

Once the micro level predictions are generated, micro prediction module 204 may trigger macro prediction module 206. Macro prediction module 206 may be configured to generate macro-level predictions. For example, macro prediction module 206 may be configured to generate season simulations based on the input data.

To generate the macro-level predictions, macro prediction module 206 may retrieve micro-level predictions generated by micro prediction module 204 from data store 118. Macro prediction module 206 may format or re-format the micro-level predictions to prepare the micro-level predictions for input into a simulation algorithm. In some embodiments, the formatting may refer to the structure and schedule of the specific competition of a league (i.e., soccer league), which could have different rules for promotion/relegation or European spots. In some embodiments, the specific competition may be a tournament (e.g., World Cup or Euro Cup, which has different criteria for making into the next round). The simulation algorithm may be configured to aggregate the micro-level predictions to generate three types of predictions: league standings, team statistics, and player statistics.

To generate each prediction type, macro prediction module 206 may initialize a for loop that goes through the various prediction types. Each iteration may correspond to a respective prediction type. For each prediction type, macro prediction module 206 may gather the micro-level predictions, execute the simulation algorithm that will aggregate the micro-level predictions, and store the outputs from the simulation algorithm.

In some embodiments, while each simulation function is different, macro prediction module 206 may utilize a Monte Carlo simulation algorithm to generate the simulated league standings, simulated team statistics, and simulated player statistics.

For example, to generate the league standings prediction, macro prediction module 206 may retrieve, from data store 118, exact score predictions for all games in the season that have not yet ended, i.e., games currently being played or have yet to be played. In some embodiments, each score prediction may be represented as a two-dimensional probability mass function that includes the estimated probabilities of every possible result. Macro prediction module 206 may sample N times from each of the two-dimensional probability mass functions. This provides N simulated exact score outcomes for every game. For a given team T, macro prediction module 206 now has N simulated outcomes for M games (e.g., the M games left to be played that involve team T). Macro prediction module 206 may add up the number of points that team T gets in each simulation run. Such process leaves macro prediction module 206 with N samples of the remaining number of points that team T gets in what is left of the season, which may be used as an approximation of the true underlying probability mass function. Generally, the larger the N used during the sampling step, the smoother the true underlying probability mass function.

In some embodiments, macro prediction module 206 may add the current number of points that team T has earned to produce the final end-of-season projection. For example, macro prediction module 206 may add the number of points that team T has earned in the games played between the start of the season and the point at which the simulation is run. Such process may be performed for all teams involved in the league to generate an end-of-season league standing probabilistic prediction.

In some embodiments, macro prediction module 206 may repeat the foregoing process for each team's “goals scored” and “goals conceded” statistics, separately. In this manner, macro prediction module 206 may generate predictions for each team's end-of-season goals for/against tallies, which may be needed to resolve any tie situations in the standings.

Macro prediction module 206 may post the generated predictions to a data stream. For example, macro prediction module 206 may publish the predictions to a Kinesis stream, so that the predictions can be made available to end users via an API feed.

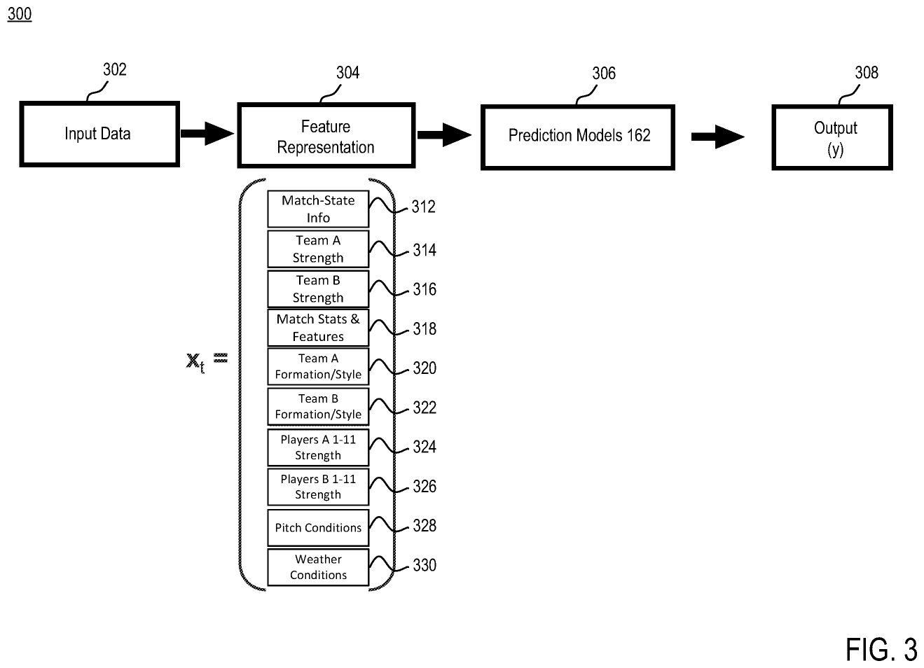

FIG. 3 is a block diagram illustrating a micro prediction process 300, according to example embodiments.

As shown, at step 302, organization computing system 104 may receive one or more data feeds. One or more data feeds may be associated with real-time or near real-time data associated with a sports event. In some embodiments, real-time or near real-time sports data (e.g., from a Runningball data feed) may be combined with enhanced or advanced sports data (e.g., from an Opta data feed). In some embodiments, the one or more data feeds may further include in-venue tracking or broadcast tracking live (or could use tracking data pre-game) as well as any other type of live sports data (e.g., market data, wearable data, etc.).

At step 304, organization computing system 104 may parse the input data set to generate a feature representation of the data for input to micro prediction module 204. For example, using the real-time or near real-time sports data with enhanced or advanced sports data, feature generation module 202 may generate model features for use with micro prediction module 204 based on the combined data set. In some embodiments, feature generation module 202 may access historical information stored in game files 126 of data store 118. In some embodiments, feature generation module 202 may access real-time or near real-time data via one or more APIs associated with Opta Data Feeds. For example, feature generation module 202 may submit one or more GET requests to a soccer Opta SDAPI.

In some embodiments, the features generated by feature generation module 202 may be grouped into a plurality of sets based on the type of prediction for which the feature is used and the context to which the feature is related. In some embodiments, feature generation module 202 may generate the features for a specific game, and the downstream models may use the features to make predictions about the specific game. Exemplary feature groups may include: pre-game team features, in-game team features, player usage features, pre-game player features, and in-game player features.

As shown, feature generation module 202 may generate a feature representation of the data, illustrated as xₜ. Such feature representation may include, but is not limited to, match state information 312, Team A strength 314, Team B strength 316, match statistics and features 318, Team A formation/style 320, Team B formation/style 322, strength of each player on Team A 324, strength of each player on Team B 326, pitch conditions 328, weather conditions 330, and the like. This vector may include the above model features.

At step 306, organization computing system 104 may provide the feature representation, as input, to one or more prediction models. For example, micro prediction module 204 may selectively retrieve features, generated by feature generation module 202, from data store 118. Using the retrieved features, micro prediction module 204 may make one or more HTTP requests to endpoints where the various prediction models are deployed to generate the micro predictions. Micro prediction module 204 may receive the various micro predictions from the one or more prediction models. For example, micro prediction module 204 may receive, as output from the prediction models, outputs yₜ. Example outputs may include, but are not limited to, win probability, team propositions (e.g., shots, goals, passes, fouls, yellow-cards, red-cards, free kicks, corners, etc.), player propositions (e.g., shots, goals, passes, fouls, yellow-cards, red cards, minutes, etc.), and the like.

At step 308, organization computing system 104 may publish the received micro predictions. For example, Once the predictions are generated and received from the various prediction models, micro prediction module 204 may format and write the predictions to data store 118. In some embodiments, the predictions may be stored in a table separate from a table storing the generated features. Micro prediction module 204 may further publish the received predictions to one or more data streams. For example, micro prediction module 204 may publish the received predictions to a Kinesis data stream. In some embodiments, micro prediction module 204 may publish the team-level predictions to a first data stream and the player-level predictions to a second data stream.

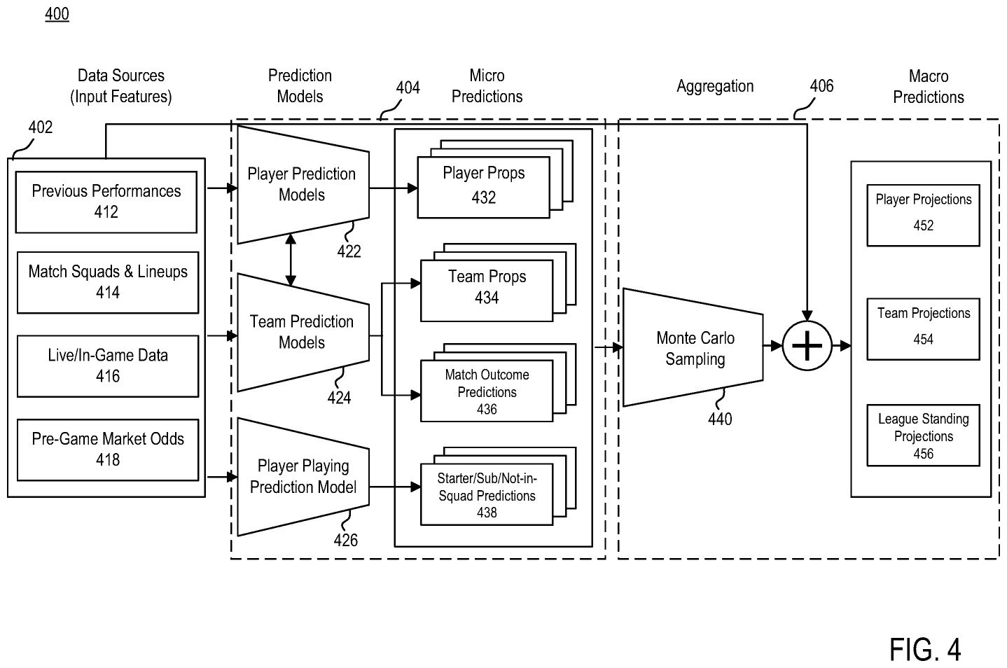

FIG. 4 is a block diagram illustrating a macro prediction process 400, according to example embodiments.

As shown, at step 402, organization computing system 104 may receive one or more data feeds. One or more data feeds may be associated with real-time or near real-time data associated with a sports event. In some embodiments, real-time or near real-time sports data (e.g., from a Runningball data feed) may be combined with enhanced or advanced sports data (e.g., from an Opta data feed) and with pre-game market odds to generate an input data set. As shown, input data features may include, but are not limited to, previous performances 412, match squads and lineups 414, live/in-game data 416, and pre-game market odds 418.

In some embodiments, feature generation module 202 may parse the input data set to generate a feature representation of the data for use with micro prediction module 204 and macro prediction module 206. For example, using the real-time or near real-time sports data with enhanced or advanced sports data, feature generation module 202 may generate model features for use with micro prediction module 204 and macro prediction module 206 based on the combined data set. In some embodiments, feature generation module 202 may access historical information stored in game files 126 of data store 118. In some embodiments, feature generation module 202 may access real-time or near real-time data via one or more APIs associated with Opta Data Feeds. For example, feature generation module 202 may submit one or more GET requests to a soccer Opta SDAPI.

At step 404, micro prediction module 202 may generate one or more micro predictions. For example, micro prediction module 204 may selectively retrieve features, generated by feature generation module 202, from data store 118. Using the retrieved features, micro prediction module 204 may make one or more HTTP requests to endpoints where the various prediction models are deployed to generate the micro predictions. As shown, exemplary prediction models may include, but are not limited to, player prediction models 422, team prediction models 424, and player playing prediction models 426.

Micro prediction module 204 may receive the various micro predictions from the one or more prediction models. For example, micro prediction module 204 may receive, as output from the prediction models, outputs yₜ. Example outputs may include, but are not limited to, player propositions 432 (e.g., shots, goals, passes, fouls, yellow-cards, red cards, minutes, etc.), team propositions 434 (e.g., shots, goals, passes, fouls, yellow-cards, red-cards, free kicks, corners, etc.), match outcome predictions 436, starter/sub/not-in-squad predictions 438, and the like.

Accordingly, in this manner, micro prediction module 204 is able to generate predicted win probabilities, team propositions, and player propositions at any point during the course of any game.

In some embodiments, an exemplary output may be a momentum value. For example, a possession value is an underlying model that powers a momentum prediction model. The possession value may measure the probability that a team will score in the next 10 seconds. In some embodiments, the possession value may measure all types of actions (e.g., carries, passes, etc.) that a player makes all over the playing surface. This allows the system to credit players who may not typically be involved in the final few actions before a goal. Micro prediction module 204 may consider all of the contributions of a player and may evaluate whether their positive actions outweigh their negative actions.

At step 406, organization computing system 104 may utilize macro prediction module 206 to generate one or more macro-level predictions. For example, micro prediction module 204 may initiate the macro prediction process by triggering macro prediction module 206. Macro prediction module 206 may generate macro-level predictions by generating season simulations based on the input data.

To generate the macro-level predictions, macro prediction module 206 may retrieve micro-level predictions generated by micro prediction module 204 from data store 118. Macro prediction module 206 may utilize a simulation algorithm to aggregate the micro-level predictions to generate three types of predictions: league standings, team statistics, and player statistics.

To generate each prediction type, macro prediction module 206 may initialize a for loop that goes through the various prediction types. Each iteration may correspond to a respective prediction type. For each prediction type, macro prediction module 206 may gather the micro-level predictions, execute the simulation algorithm that will aggregate the micro-level predictions, and store the outputs from the simulation algorithm.

While each simulation function is different, macro prediction module 206 may utilize a Monte Carlo simulation algorithm (e.g., Monte Carlo Sampling 440) to generate the simulated league standings 456, simulated team statistics 454, and simulated player statistics 452.

Macro prediction module 206 may post the generated predictions to a data stream. For example, macro prediction module 206 may publish the predictions to a Kinesis stream, so that the predictions can be made available to end users via an API feed.

Accordingly, in this manner, macro prediction module 206 is able to simulate league standings, simulated team statistics, and simulated player statistics at any point during the course of any game.

In some embodiments, an exemplary output may take the form of a dominance prediction. For example, based on the micro predictions generated by micro prediction module 204, macro prediction module 206 may utilize recent-team and/or player features to determine whether a team has a dominant style against another team.

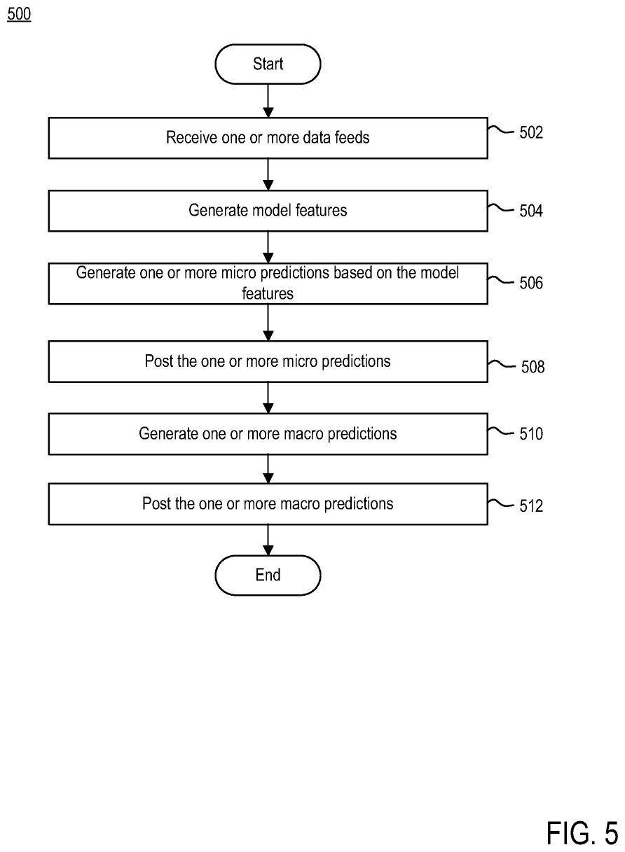

FIG. 5 is a flow diagram illustrating a method 500 of generating micro predictions and macro predictions in sport, according to example embodiments. Method 500 may begin at step 502.

At step 502, organization computing system 104 may receive one or more data feeds. One or more data feeds may be associated with real-time or near real-time data associated with a sports event. In some embodiments, real-time or near real-time sports data (e.g., from a Runningball data feed) may be combined with enhanced or advanced sports data (e.g., from an Opta data feed) and with pre-game market odds to generate an input data set.

At step 504, organization computing system 104 may generate model features for use with micro prediction module 204 and macro prediction module 206. For example, feature generation module 202 may obtain data related to teams or players in a current game of interest, as well as historical games of interest related to the teams, players, and/or other teams and players. In some embodiments, feature generation module 202 may access historical information stored in game files 126 of data store 118. In some embodiments, feature generation module 202 may access real-time or near real-time data via one or more APIs associated with Opta Data Feeds. For example, feature generation module 202 may submit one or more GET requests to a soccer Opta SDAPI.

In some embodiments, feature generation module 202 may grouped the generated features into a plurality of sets based on the type of prediction for which the feature is used and the context to which the feature is related. In some embodiments, feature generation module 202 may generate the features for a specific game, and the downstream models may use the features to make predictions about the specific game. Exemplary feature groups may include: pre-game team features, in-game team features, player usage features, pre-game player features, and in-game player features.

At step 506, organization computing system 104 may generate one or more micro predictions based on the generated model features. For example, micro prediction module 204 may selectively retrieve features, generated by feature generation module 202, from data store 118. Using the retrieved features, micro prediction module 204 may make one or more HTTP requests to endpoints where the various prediction models are deployed to generate the micro predictions. Micro prediction module 204 may receive the various micro predictions from the one or more prediction models. For example, micro prediction module 204 may receive, as output from the prediction models, outputs yₜ. Example outputs may include, but are not limited to, win probability, team propositions (e.g., shots, goals, passes, fouls, yellow-cards, red-cards, free kicks, corners, etc.), player propositions (e.g., shots, goals, passes, fouls, yellow-cards, red cards, minutes, etc.), and the like.

At step 508, organization computing system 104 may post the one or more micro predictions. For example, micro prediction module 204 may publish the received predictions to a Kinesis data stream. In some embodiments, micro prediction module 204 may publish the team-level predictions to a first data stream and the player-level predictions to a second data stream.

At step 510, organization computing system 104 may generate one or more macro predictions. For example, micro prediction module 204 may initiate the macro prediction process by triggering macro prediction module 206. Macro prediction module 206 may generate macro-level predictions by generating season simulations based on the input data.

To generate the macro-level predictions, macro prediction module 206 may retrieve micro-level predictions generated by micro prediction module 204 from data store 118. Macro prediction module 206 may utilize a simulation algorithm to aggregate the micro-level predictions to generate three types of predictions: league standings, team statistics, and player statistics.

To generate each prediction type, macro prediction module 206 may initialize a for loop that goes through the various prediction types. Each iteration may correspond to a respective prediction type. For each prediction type, macro prediction module 206 may gather the micro-level predictions, execute the simulation algorithm that will aggregate the micro-level predictions, and store the outputs from the simulation algorithm.

While each simulation function is different, macro prediction module 206 may utilize a Monte Carlo simulation algorithm to generate the simulated league standings, simulated team statistics, and simulated player statistics.

At step 512, organization computing system 104 may post the one or more macro predictions. In some embodiments, macro prediction module 206 may post the generated predictions to a data stream. For example, macro prediction module 206 may publish the predictions to a Kinesis stream, so that the predictions can be made available to end users via an API feed.

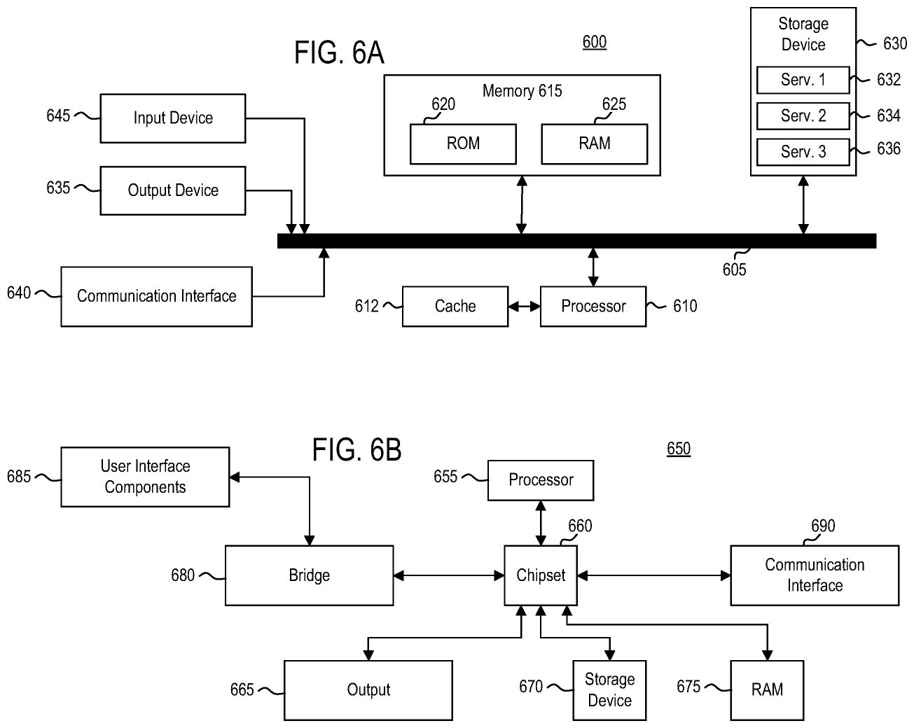

FIG. 6A illustrates a system bus architecture of computing system 600, according to example embodiments. System 600 may be representative of at least a portion of organization computing system 104. One or more components of system 600 may be in electrical communication with each other using a bus 605. System 600 may include a processing unit (CPU or processor) 610 and a system bus 605 that couples various system components including the system memory 615, such as read only memory (ROM) 620 and random access memory (RAM) 625, to processor 610. System 600 may include a cache of high-speed memory connected directly with, in close proximity to, or integrated as part of processor 610. System 600 may copy data from memory 615 and/or storage device 630 to cache 612 for quick access by processor 610. In this way, cache 612 may provide a performance boost that avoids processor 610 delays while waiting for data. These and other modules may control or be configured to control processor 610 to perform various actions. Other system memory 615 may be available for use as well. Memory 615 may include multiple different types of memory with different performance characteristics. Processor 610 may include any general-purpose processor and a hardware module or software module, such as service 1 632, service 2 634, and service 3 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction with the computing system 600, an input device 645 may represent any number of input mechanisms, such as a microphone for speech, a touch-sensitive screen for gesture or graphical input, keyboard, mouse, motion input, speech and so forth. An output device 635 (e.g., display) may also be one or more of a number of output mechanisms known to those of skill in the art. In some instances, multimodal systems may enable a user to provide multiple types of input to communicate with computing system 600. Communications interface 640 may generally govern and manage the user input and system output. There is no restriction on operating on any particular hardware arrangement and therefore the basic features here may easily be substituted for improved hardware or firmware arrangements as they are developed.

Storage device 630 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 625, read only memory (ROM) 620, and hybrids thereof.

Storage device 630 may include services 632, 634, and 636 for controlling the processor 610. Other hardware or software modules are contemplated. Storage device 630 may be connected to system bus 605. In one aspect, a hardware module that performs a particular function may include the software component stored in a computer-readable medium in connection with the necessary hardware components, such as processor 610, bus 605, output device 635, and so forth, to carry out the function.

FIG. 6B illustrates a computer system 650 having a chipset architecture that may represent at least a portion of organization computing system 104. Computer system 650 may be an example of computer hardware, software, and firmware that may be used to implement the disclosed technology. System 650 may include a processor 655, representative of any number of physically and/or logically distinct resources capable of executing software, firmware, and hardware configured to perform identified computations. Processor 655 may communicate with a chipset 660 that may control input to and output from processor 655. In this example, chipset 660 outputs information to output 665, such as a display, and may read and write information to storage device 670, which may include magnetic media, and solid state media, for example. Chipset 660 may also read data from and write data to RAM 675. A bridge 680 for interfacing with a variety of user interface components 685 may be provided for interfacing with chipset 660. Such user interface components 685 may include a keyboard, a microphone, touch detection and processing circuitry, a pointing device, such as a mouse, and so on. In general, inputs to system 650 may come from any of a variety of sources, machine generated and/or human generated.

Chipset 660 may also interface with one or more communication interfaces 690 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 655 analyzing data stored in storage device 670 or RAM 675. Further, the machine may receive inputs from a user through user interface components 685 and execute appropriate functions, such as browsing functions by interpreting these inputs using processor 655.

It may be appreciated that example systems 600 and 650 may have more than one processor 610 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method, comprising:
receiving, by a computing system, a data feed for an event, wherein the data feed comprises real-time player and team information;
generating, by the computing system, a model features for use with a micro prediction module and a macro prediction module based on the data feed and historical information associated with teams and/or players in the event;
generating, by the computing system, micro predictions for the event, wherein the micro predictions for the event are associated with player and team predictions at an event level;
generating, by the computing system, macro predictions for the players and the teams involved in the event based on the model features and the micro predictions generated by the micro prediction module; and
posting, by the computing system, the micro predictions and the macro predictions to an event feed.

2. The method of claim 1, further comprising:
receiving, by the computing system from a user device, a request for a certain prediction within a target event;
retrieving, by the computing system, current information for the event, the current information for the event comprising event and player context data; and
generating, by the computing system, a target micro prediction based on the request from the user device.

3. The method of claim 1, further comprising:
receiving, by the computing system from a virtual assistant, a request for a certain prediction within a target event;
retrieving, by the computing system, current information for the event, the current information for the event comprising event and player context data;
generating, by the computing system, a target micro prediction based on the request from the virtual assistant; and
causing, by the computing system, the virtual assistant to generate an audible output corresponding to the target micro prediction.

4. The method of claim 1, further comprising:
receiving, by the computing system from a user device, a request for a certain prediction within a target event;
retrieving, by the computing system, current information for the event, the current information for the event comprising event and player context data;
retrieving, by the computing system, pre-event market odds for the event; and
generating, by the computing system, a target macro prediction based on the request from the user device.

5. The method of claim 1, wherein generating, by the computing system, the micro predictions for the event comprises:
generating, by the micro prediction module, one or more hypertext transfer protocol requests to endpoints where a plurality of prediction models are deployed to generate the micro predictions.

6. The method of claim 1, wherein generating, by the computing system, the macro predictions for the players and the teams involved in the event comprises:
aggregating the micro predictions using a simulation algorithm to generate league standing predictions, team statistics predictions, and/or player statistic predictions.

7. The method of claim 1, wherein generating, by the computing system, the model features for use with the micro prediction module and the macro prediction module comprises:
detecting a trigger event that causes the computing system to generate the model features from the data feed.

8. A non-transitory computer readable medium comprising one or more sequences of instructions, which, when executed by a processor, causes a computing system to perform operations comprising:
receiving, by the computing system, a data feed for an event, wherein the data feed comprises real-time player and team information;
generating, by the computing system, a model features for use with a micro prediction module and a macro prediction module based on the data feed and historical information associated with teams and/or players in the event;
generating, by the computing system, micro predictions for the event, wherein the micro predictions for the event are associated with player and team predictions at an event level;
generating, by the computing system, macro predictions for the players and the teams involved in the event based on the model features and the micro predictions generated by the micro prediction module; and
posting, by the computing system, the micro predictions and the macro predictions to an event feed.

9. The non-transitory computer readable medium of claim 8, further comprising:
receiving, by the computing system from a user device, a request for a certain prediction within a target event;
retrieving, by the computing system, current information for the event, the current information for the event comprising event and player context data; and
generating, by the computing system, a target micro prediction based on the request from the user device.

10. The non-transitory computer readable medium of claim 8, further comprising:
receiving, by the computing system from virtual assistant, a request for a certain prediction within a target event;
retrieving, by the computing system, current information for the event, the current information for the event comprising event and player context data;
generating, by the computing system, a target micro prediction based on the request from the virtual assistant; and
causing, by the computing system, the virtual assistant to generate an audible output corresponding to the target micro prediction.

11. The non-transitory computer readable medium of claim 8, further comprising:
receiving, by the computing system from a user device, a request for a certain prediction within a target event;
retrieving, by the computing system, current information for the event, the current information for the event comprising event and player context data;
retrieving, by the computing system, pre-event market odds for the event; and
generating, by the computing system, a target macro prediction based on the request from the user device.

12. The non-transitory computer readable medium of claim 8, wherein generating, by the computing system, the micro predictions for the event comprises:
generating, by the micro prediction module, one or more hypertext transfer protocol requests to endpoints where a plurality of prediction models are deployed to generate the micro predictions.

13. The non-transitory computer readable medium of claim 8, wherein generating, by the computing system, the macro predictions for the players and the teams involved in the event comprises:
aggregating the micro predictions using a simulation algorithm to generate league standing predictions, team statistics predictions, and/or player statistic predictions.

14. The non-transitory computer readable medium of claim 8, wherein generating, by the computing system, the model features for use with the micro prediction module and the macro prediction module comprises:
detecting a trigger event that causes the computing system to generate the model features from the data feed.

15. A system comprising:
a processor; and
a memory having programming instructions stored thereon, which, when executed by the processor, causes the system to perform operations comprising:
receiving a data feed for an event, wherein the data feed comprises real-time player and team information;
generating a model features for use with a micro prediction module and a macro prediction module based on the data feed and historical information associated with teams and/or players in the event;
generating micro predictions for the event, wherein the micro predictions for the event are associated with player and team predictions at an event level;
generating macro predictions for players and teams involved in the event based on the model features and the micro predictions generated by the micro prediction module; and
posting the micro predictions and the macro predictions to an event feed.

16. The system of claim 15, wherein the operations further comprise:
receiving, from a user device, a request for a certain prediction within a target event;
retrieving current information for the event, the current information for the event comprising event and player context data; and
generating a target micro prediction based on the request from the user device.

17. The system of claim 15, wherein the operations further comprise:
receiving, from virtual assistant, a request for a certain prediction within a target event;
retrieving current information for the event, the current information for the event comprising event and player context data;
generating a target micro prediction based on the request from the virtual assistant; and
causing the virtual assistant to generate an audible output corresponding to the target micro prediction.

18. The system of claim 15, wherein the operations further comprise:
receiving, from a user device, a request for a certain prediction within a target event;
retrieving current information for the event, the current information for the event comprising event and player context data;
retrieving pre-event market odds for the event; and
generating a target macro prediction based on the request from the user device.

19. The system of claim 15, wherein generating the micro predictions for the event comprises:
generating, by the micro prediction module, one or more hypertext transfer protocol requests to endpoints where a plurality of prediction models are deployed to generate the micro predictions.

20. The system of claim 15, wherein generating the macro predictions for the players and the teams involved in the event comprises:
aggregating the micro predictions using a simulation algorithm to generate league standing predictions, team statistics predictions, and/or player statistic predictions.
